(19) United States
(12) Patent Application Publication
(10) Pub. No.: US 2012/0233403 A1
(43) Pub. Date: Sep. 13, 2012

(54) ELECTRONIC DEVICE, CONTROL METHOD THEREOF, PROGRAM, AND STORAGE MEDIUM

(75) Inventor: Kiyoshi YOSHIKAWA, Saitama (JP)

(73) Assignee: Sony Corporation, Tokyo (JP)

(21) Appl. No.: 13/402,339

(22) Filed: Feb. 22, 2012

(30) Foreign Application Priority Data
Mar. 11, 2011 (JP) 2011-053843

(51) Int. Cl. G06F 12/00

(52) U.S. Cl. 711/115; 711/E12.001

(57) ABSTRACT

An electronic device is provided. The electronic device includes a drive for attaching a removable storage, a reader for reading update information acquired from a network through a device having a network connection function when the removable storage is attached to the drive, the information being recorded in a predetermined directory in the removable storage, and a writer for writing device information necessary for acquiring the update information in a predetermined directory in the removable storage when the removable storage is attached to the drive. The electronic device is not provided with a function for connecting to the network.

### BACKGROUND

The present disclosure relates to an electronic device, a control method of the electronic device, a program, and a storage medium. More particularly, the present disclosure relates to an electronic device capable of notifying a device, which is not provided with an interface for connecting to a network, of information, or updating and providing information to the device, a control method of the electronic device, a program, and a storage medium.

In recent years, many consumer electronics (CE) devices such as digital cameras, portable music players, and the like have been developed. Such CE devices are widely used in daily life.

Meanwhile, with the spread use of the Internet, information is gathered through the Internet widely and commonly. For example, when basic software used in various electronic devices is updated, the latest version of the basic software is downloaded through the Internet and installed.

In these circumstances, Internet connection from the CE devices has been expected.

For example, Japanese Unexamined Patent Application Publication No. 2005-208685 proposes a technique for storing information in a device in an off-line state where the device is not connected to the Internet, and notifying a server of information or, updating and providing information in an on-line state by communicating with the server.

### SUMMARY

However, in the technique proposed in Japanese Unexamined Patent Application Publication No. 2005-208685, it is not possible to notify a device, which is not provided with a connection interface to a network, of information or to update and provide information to the device.

The present disclosure has been made in view of the above circumstances. It is desirable to notify a device, which is not provided with a connection interface to a network, of information or to update and provide information to the device.

According to an embodiment of the present disclosure, there is provided an electronic device including a drive for attaching a removable storage that is an detachable recording medium, a reader for reading update information acquired from a network through a device having a network connection function when the removable storage is attached to the drive, the information being recorded in a predetermined directory in the removable storage, and a writer for writing device information necessary for acquiring the update information in a predetermined directory in the removable storage when the removable storage is attached to the drive. The electronic device is not provided with a function for connecting to the network.

The device having the network connection function can access a predetermined server connected to the network, and acquire the update information from the server using the device information stored in the predetermined directory in the removable storage.

The device information includes attributes of a predetermined number and attribute values, and the device having the network connection function can specify the update information to be provided to the electronic device by extracting a predetermined attribute value from the attributes.

As the update information, a file of basic software of a new version to be implemented in the electronic device can be written.

As the update information, contents corresponding a predetermined address on the network can be written after being updated.

In the device information, a parameter for specifying timing for the device having the network function to access a server connected to the network can be described.

The device information includes information indicating an operational state of the electronic device, and the device having the network connection function can read the device information recorded in the predetermined directory in the removable storage, access a predetermined server connected to the network, and send the information indicating the operational state of the electronic device to the server.

According to another embodiment of the present disclosure, there is provided a method for controlling an electronic device that is not provided with a function of connecting to a network. The method includes reading update information acquired from the network through a device having a network connection function when a removable storage that is a detachable recording medium is attached to a drive for attaching the removable storage, the information being recorded in a predetermined directory in the removable storage, and writing device information necessary for acquiring the update information in a predetermined directory in the removable storage when the removable storage is attached to the drive.

According to still another embodiment of the present disclosure, there is provided a program instructing a computer to function as an electronic device that is not provided with a function for connecting to a network. The electronic device includes a drive for attaching a removable storage that is a detachable recording medium, a reader for reading update information acquired from the network through a device having a network connection function when the removable storage is attached to the drive, the information being recorded in a predetermined directory in the removable storage, and a writer for writing device information necessary for acquiring the update information in a predetermined directory in the removable storage when the removable storage is attached to the drive.

According to an embodiment of the present disclosure, update information acquired from a network through a device having a network connection function is read when a removable storage that is a detachable recording medium is attached to a drive for attaching the removable storage, the information being recorded in a predetermined directory in the removable storage, and device information necessary for acquiring the update information is written in a predetermined directory in the removable storage when the removable storage is attached to the drive.

According to the embodiments of the present disclosure, a device that is not provided with a connection interface to a network can be notified of information, or information can be updated and provided to the device.

### BRIEF DESCRIPTION OF THE DRAWINGS

FIG. 1 illustrates an example of a configuration of an information updating system according to an embodiment of the present technology.

FIG. 2 is a block diagram illustrating an example of a configuration of a network connection device illustrated in FIG. 1.

FIG. 3 is a block diagram illustrating an example of a configuration of a CE device illustrated in FIG. 1.

FIG. 4 illustrates an example of a detailed configuration of CE device information.

FIG. 5 illustrates an example of specific information described in the attribute “Type”, the attribute “Key”, and the attribute “Value” in FIG. 4.

FIG. 6 is an arrow diagram illustrating a flow of processing for notifying the CE device of new information or providing new information to the CE device in the information updating system in FIG. 1.

### DETAILED DESCRIPTION OF EMBODIMENTS

Hereinafter, embodiments of the present technology will be described with reference to the attached drawings.

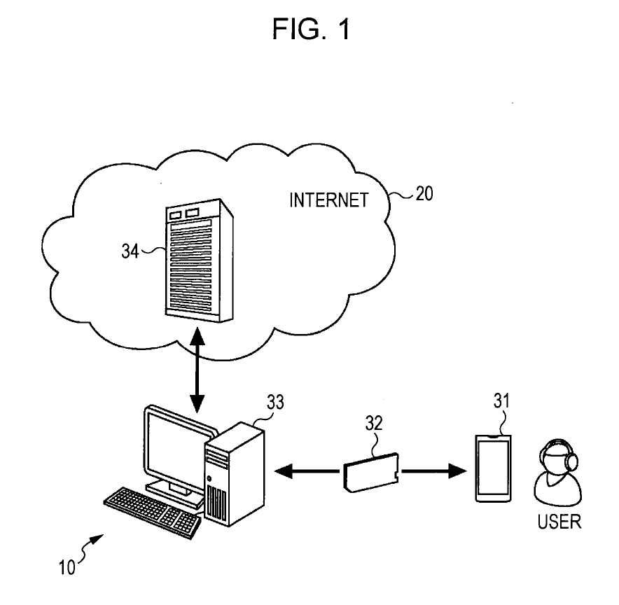

FIG. 1 illustrates an example of a configuration of an information updating system according to an embodiment of the present technology. An information updating system 10 illustrated in FIG. 1 includes a CE device 31, a removable mass storage 32, a network connection device 33, and a distribution server 34 on the Internet 20.

The CE device 31 is, for example, a portable music player. The CE device 31 is not provided with a wired or wireless network connection interface. However, the CE device 31 includes an interface such as a drive for attaching or detaching the removable mass storage 32.

The CE device 31 is not limited to the portable media player, but the CE device 31 may be, for example, a digital camera, a television receiver, or other home electric appliances. In other words, the CE device 31 may be any device that is not provided with a wired or wireless network connection interface, but is provided with an interface such as a drive for attaching or detaching the removable mass storage 32.

The removable mass storage 32 is a detachable recording medium. The removable mass storage 32 is a recording medium, for example, a universal serial bus (USB) memory, a memory stick, and a Secure Digital (SD) card.

The network connection device 33 is an electronic device that has an interface for connecting to the Internet 20, and an interface such as a drive for attaching or detaching the removable mass storage 32. The network connection device 33 is, for example, a personal computer.

The distribution server 34 is, for example, a computer that has a relatively high processing ability. The distribution server 34 may be a virtual distribution server using a plurality of computers on the Internet 20.

In the information updating system 10, the CE device 31 that is not provided with a network connection interface can be notified of or provided with new information on the Internet 20. In other words, the CE device 31 can acquire the information from the distribution server 34 through the removable mass storage 32.

Consequently, in the information updating system 10, for example, basic software such as an operating system (OS) or firmware can be updated at appropriate timing.

The information to be recorded in the removable mass storage 32 is associated with a predetermined directory and stored. When the removable mass storage 32 is attached, the CE device 31 reads the information recorded in the predetermined directory. When the removable mass storage 32 is attached, the CE device 31 writes CE device information in a predetermined directory.

The CE device information includes, for example, an ID of the CE device 31, destination information (for example, to Japan, to the United States, or the like) of the CE device 31, and a serial number of the CE device 31. Further, the CE device information includes information for identifying the version of firmware, an application program, contents, and the like, and information about operational states (for example, the frequency of use, and an error occurrence state).

When the removable mass storage 32 is attached, the network connection device 33 accesses the predetermined directory, and reads the above-described CE device information. The network connection device 33 accesses the distribution server 34 through the Internet 20, and instructs the distribution server 34 to retrieve new information that the CE device 31 is notified of.

As will be described below, in order to specify the information to be provided to the CE device, in the CE device information, various attributes and attribute values are specified in advance. The network connection device 33, for example, specifies the information to be provided to the CE device by extracting an attribute value of a predetermined attribute in the CE device information. Then, the network connection device 33 instructs the distribution server 34 to retrieve whether the information is updated, for example.

For example, in a case where the firmware of a new version in the CE device 31 is released, the distribution server 34 transmits a file of the firmware of the new version as a retrieval result to the network connection device 33. The retrieval result is acquired by the network connection device 33 as new information that the CE device 31 is notified of or provided with.

When the network connection device 33 acquires the new information that the CE device 31 is notified of, the network connection device 33 writes the information in a predetermined directory in the removable mass storage 32.

Consequently, for example, if the user detaches the removable mass storage 32 from the CE device 31, and attaches the storage 32 to the network connection device 33, as described above, the firmware of the new version is recorded in the removable mass storage 32. If the user detaches the removable mass storage 32 from the network connection device 33, and attaches the storage 32 to the CE device 31, as described above, the firmware of the new version is read in the CE device 31 and the firmware is updated.

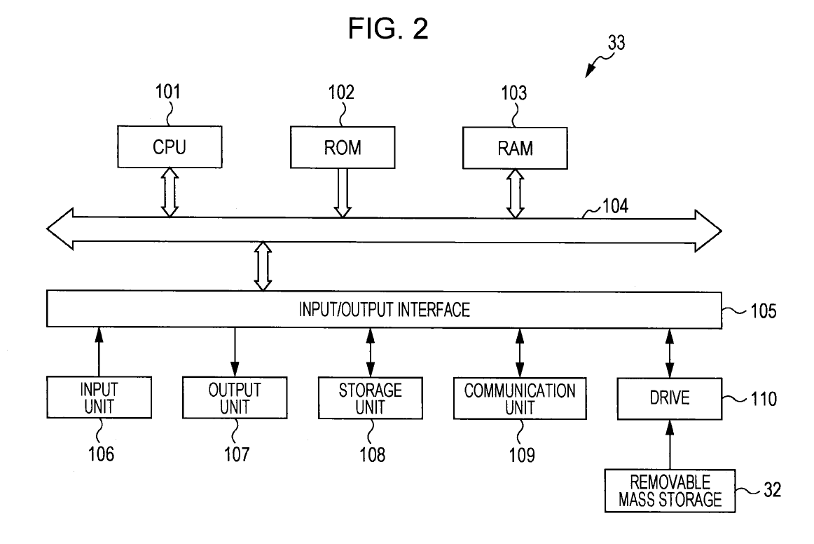

FIG. 2 is a block diagram illustrating an example of a configuration of the network connection device 33 illustrated in FIG. 1. As described above, the network connection device 33 is, for example, a personal computer.

As illustrated in FIG. 2, the network connection device 33 includes a central processing unit (CPU) 101 that executes various types of processing according to a program stored in a read only memory (ROM) 102 or a program loaded from a storage unit 108 to a random access memory (RAM) 103. The RAM 103 further stores data necessary for the CPU 101 executing various types of processing as appropriate.

The CPU 101, the ROM 102, and the RAM 103 are interconnected through a bus 104. To the bus 104, an input/output interface 105 is also connected.

To the input/output interface 105, an input unit 106 such as a keyboard or mouse, and a display such as a liquid crystal display (LCD) are connected. Further, to the input/output interface 105, an output unit 107 such as a speaker, the storage unit 108 such as a hard disk, and a communication unit 109 such as a network interface card, for example, a modem or a LAN card are connected. The communication unit 109 performs communication processing through a network including the Internet 20.

To the input/output interface 105, further, a drive 110 is connected. To the drive 110, the above-mentioned removable mass storage 32 is attached. To the drive 110, a removable medium such as a magnetic disk, an optical disk, a magneto-optical disk, or a semiconductor memory can be attached as appropriate.

In the network connection device 33, when a series of processing operations are executed by software, a program constituting the software is installed from a network such as the Internet 20 or a recording medium such as a removable media.

The configuration of the distribution server 34 in FIG. 1 is similar to that of the network connection device 33. Accordingly, FIG. 1 is to be used as necessary.

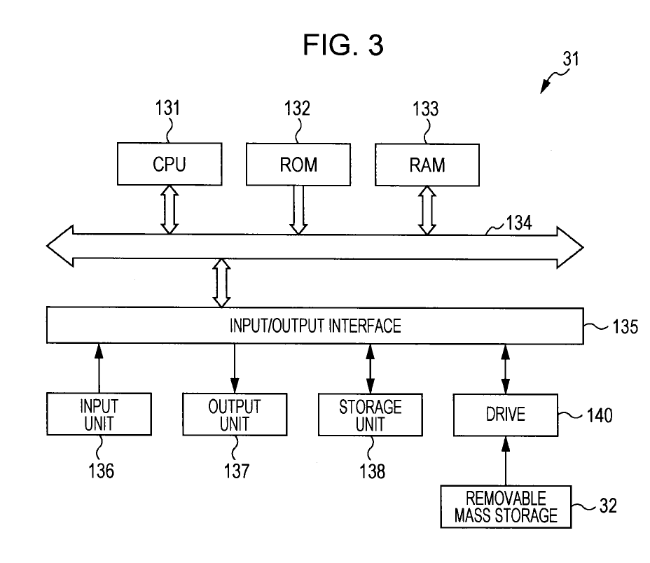

FIG. 3 is a block diagram illustrating an example of a configuration of the CE device 31 illustrated in FIG. 1. The configuration including a CPU 131 to a storage unit 138 in FIG. 3 is similar to that of the CPU 101 to the storage unit 108 in FIG. 2. Accordingly, detailed descriptions of the elements are omitted.

In the configuration in FIG. 3, different from the case in FIG. 2, a communication unit is not provided. As described above, this is because the CE device 31 is not provided with a network connection interface.

To a drive 140 in FIG. 3, the above-mentioned removable mass storage 32 is attached.

In a case where the CE device 31 is, for example, a portable music player, in the configuration in FIG. 3, music data read from the removable mass storage 32 or the storage unit 138 is decoded and reproduced through processing by a program that is executed by the CPU 131, or the like.

In a case where the CE device 31 is, for example, a digital camera, a lens or an actuator is added to the configuration in FIG. 3. Then, image capturing is controlled through processing by a program or the like executed by the CPU 131. The captured image is recorded in the removable mass storage 32 or the storage unit 138.

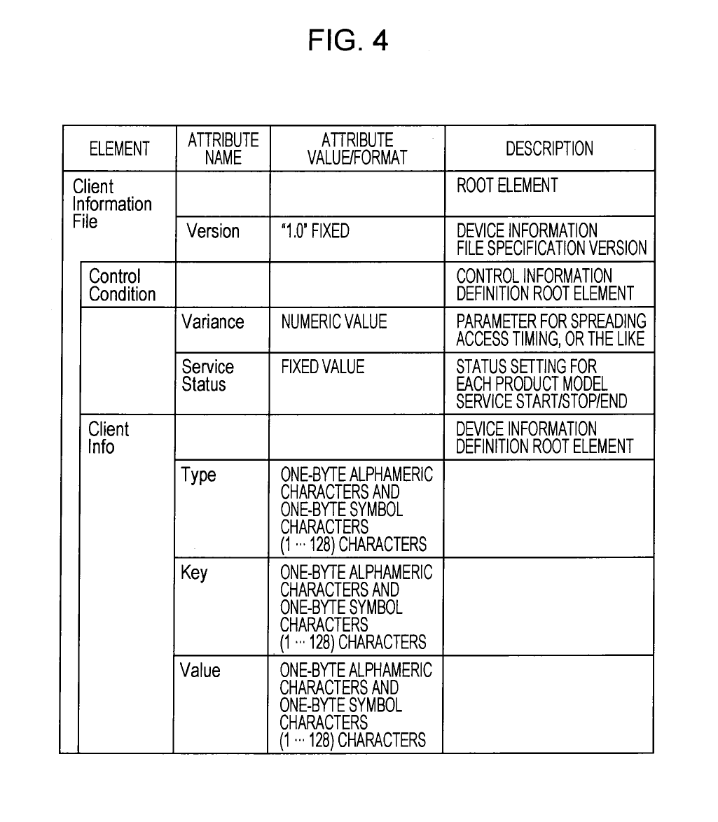

FIG. 4 illustrates an example of a detailed configuration of the above-described CE device information. In FIG. 4, the CE device information is described as a table having fields of “element”, “attribute name”, “attribute value/format”, and “description”.

As illustrated in FIG. 4, the CE device information is recorded in the removable mass storage 32 as a file termed “ClientInformationFile”. The file “ClientInformationFile” includes an element referred to as “ControlCondition” and an element referred to as “ClientInfo”.

The element “ControlCondition” includes an attribute “Variance” and an attribute “ServiceStatus”.

In the attribute “Variance”, a predetermined numerical value is described. The value is used, for example, as a parameter for specifying timing the network connection device 33 accesses the distribution server 34. For example, the numerical value described as the attribute “Variance” is used to specify time. It is possible to prohibit the network connection device 33 from accessing the distribution server 34 to retrieve new information unless the time elapsed from the last writing operation.

In the attribute “ServiceStatus”, a fixed value is described. For example, the fixed value is used as a parameter for setting a status of each product model. For example, the numerical value described as the attribute “ServiceStatus” specifies three types of dates and times, i.e., dates and times of the start of the service, the stop of the service, and the end of the service.

The attribute “ServiceStatus” can be an alphameric character or a symbol other than the fixed value. For example, as the attribute “ServiceStatus”, information about an operational state (for example, the frequency of use, an error occurrence state, a log relating to the operation of the CE device 31, or the like) can be included. For example, the network connection device 33 reads the information on the operational state (the frequency of use, an error occurrence state, or the like) and the log relating to the operation of the CE device 31. When the network connection device 33 accesses the distribution server 34, the network connection device 33 sends the above-described information on the operational state (the log) to the distribution server 34. The distribution server 34 stores the information on the operational state (the log) sent from the network connection device 33 for each CE device.

With the above-described configuration, the distribution server 34 can correct the log information, and analyze the log information about the CE device 31 that is originally not provided with the function of connecting to the Internet 20.

The element “ClientInfo” includes an attribute “Type”, an attribute “Key” and an attribute “Value”.

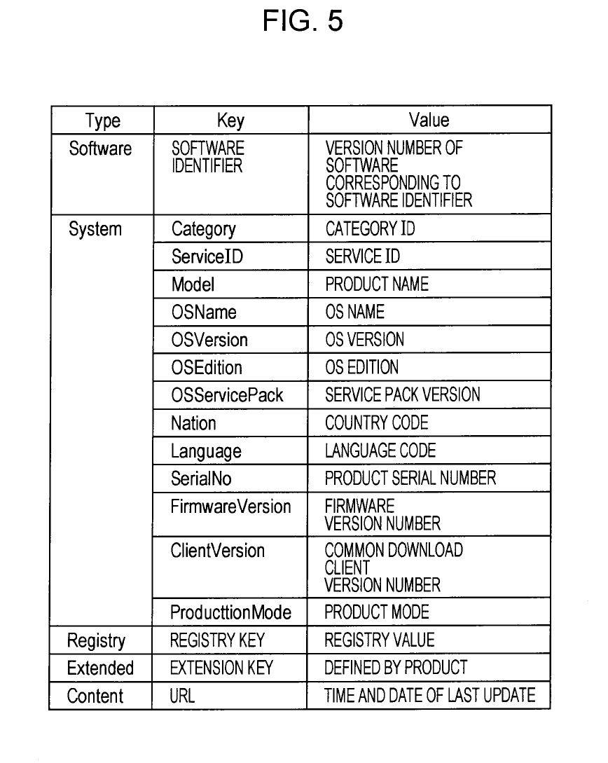

In the attribute “Type”, the attribute “Key”, and the attribute “Value”, one-byte alphameric characters and one-byte symbol characters of 1 to 128 characters are described respectively. FIG. 5 illustrates an example of specific information described in the attribute “Type”, the attribute “Key”, and the attribute “Value”.

FIG. 5 illustrates combinations of information described in the attribute “Type”, the attribute “Key”, and the attribute “Value”. For example, if “Software” is described in the attribute “Type”, “software identifier” is described in the attribute “Key” and “version number of software corresponding to software identifier” is described in the attribute “Value”.

If “System” is described in the attribute “Type”, for example, Category (the name of the category) is described in the attribute “Key”, and a category ID is described in the attribute “Value”. The category ID is, for example, an identifier of the category relating to the firmware of the CE device 31.

If “content” is described in the attribute “Type”, a URL is described in the attribute “Key” and date and time of the last update is described in the attribute “Value”. Thus, for example, each time contents (for example, concert information of a certain artist) specified by a certain URL are updated, the CE device 31 can be notified of the information.

Similarly, FIG. 5 illustrates other combinations of information described in the attribute “Type”, the attribute “Key”, and the attribute “Value”.

The element “ClientInfo” in FIG. 4 can describe a plurality of combinations of the attribute “Type”, the attribute “Key”, and the attribute “Value”. Thus, information corresponding to the CE device can be acquired.

For example, “system” is described in the attribute “Type” of the element “ClientInfo”, “FirmWareVersion” is described in the attribute “Key”, and the version number of the firmware currently implemented in the CE device 31 is described in the attribute “Value”. Accordingly, when the firmware is updated to a new version, the file of the updated firmware can be provided to the CE device 31.

In another case, for example, “content” is described in the attribute “Type” of the element “ClientInfo”, a URL is described in the attribute “Key”, and date and time of the last update is described in the attribute “Value”. Thus, when the contents are updated, the updated contents can be provided to the CE device 31.

In still another case, for example, if the firmware is updated to a new version, the updated firmware can be provided to a CE device, and to another CE device, not only the firmware, but an updated OS can be provided. In still another case, for example, if contents that can be acquired by accessing a predetermined URL are updated, the updated contents can be provided to the other CE device.

The above-described CE device information is recorded, for example, in a directory of <manufacturer identification number>/<CE device identification number>/<device information> in the removable mass storage 32. The information acquired from the distribution server 34 is recorded, for example, in a directory of <manufacturer identification number>/<CE device identification number>/<updated information> in the removable mass storage 32.

The information illustrated in FIGS. 4 and 5 is examples of the configuration of the CE device information. CE device information of a configuration different from the examples may be used. The information that can be contained in the CE device information may include information other than the information described with reference to FIGS. 4 and 5. Alternatively, a part of the information described with reference to FIGS. 4 and 5 may be omitted in the information.

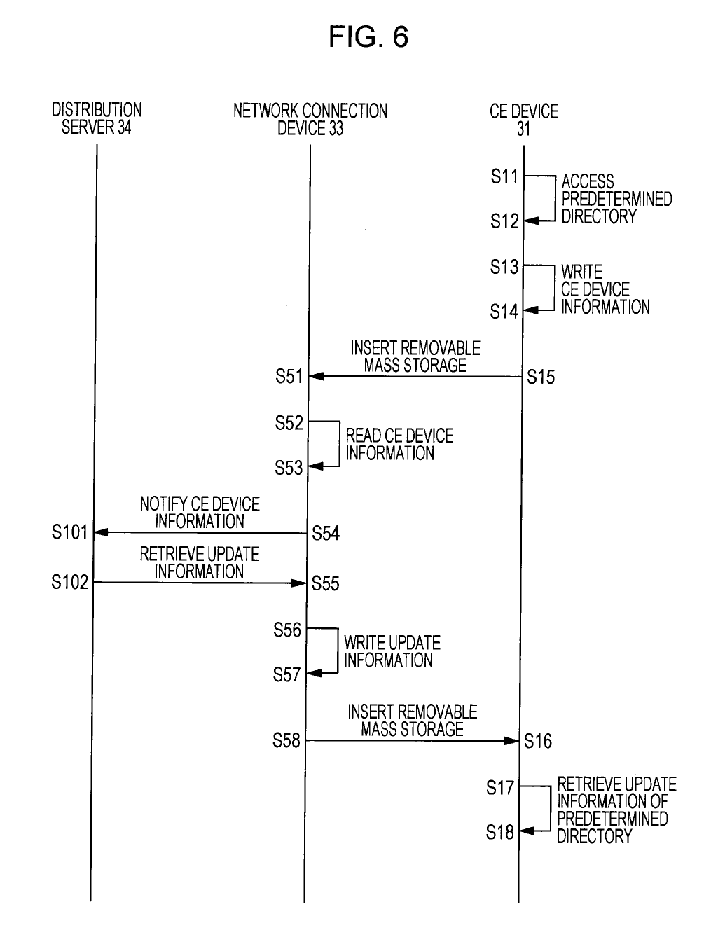

Next, in the information updating system 10 in FIG. 1, the processing flow for notifying the CE device 31, which is not provided with a network connection interface, of new information on the Internet 20 or providing the CE device 31 with the new information is described. FIG. 6 is an arrow diagram illustrating the flow of the above-described processing.

In step S11, for example, the user attaches the removable mass storage 32 to the CE device 31. In step S12, the CE device 31 accesses the directory of <manufacturer identification number>/<CE device identification number>/<updated information> in the removable mass storage 32, and checks the recorded information. If new updated information has been recorded, the CE device 31 reads the updated information.

In step S13, the CE device 31, for example, accesses the directory of <manufacturer identification number>/<CE device identification number>/<device information> in the removable mass storage 32. In step S14, the CE device 31 writes the CE device information in the directory.

In step S15, for example, the user detaches the removable mass storage 32 from the CE device 31. In step S51, the detached removable mass storage 32 is attached to the network connection device 33.

In step S52, the network connection device 33, for example, accesses the directory of <manufacturer identification number>/<CE device identification number>/<device information> in the removable mass storage 32. In step S53, the network connection device 33 acquires the device information of the CE device 31.

In step S54, the network connection device 33 accesses the distribution server 34 through the Internet 20. Using the CE device information acquired in the processing in step S53, the network connection device 33 instructs the distribution server 34 to retrieve new information that the CE device 31 is notified of.

In step S101, the distribution server 34 receives data relating to the access from the network connection device 33, and executes the retrieval of the new information that the CE device 31 is notified of. For example, if a new version of the firmware of the CE device 31 has been released, the information is acquired as the new information that the CE device 31 is notified of or provided with.

In step S102, the distribution server 34 sends the network connection device 33 the new information (for example, the file of the firmware of the new version) that the CE device 31 is notified of. In step S55, the network connection device 33 receives the information.

In step S56, the network connection device 33, for example, accesses the directory of <manufacturer identification number>/<CE device identification number>/<updated information> in the removable mass storage 32. In step S57, the network connection device 33 writes the information received in step S55 in the directory.

In step S58, for example, the user detaches the removable mass storage 32 from the network connection device 33. In step S16, the detached removable mass storage 32 is attached to the CE device 31.

In step S17, the CE device 31, for example, accesses the directory of <manufacturer identification number>/<CE device identification number>/<updated information> in the removable mass storage 32. In step S18, the CE device 31 reads the information (for example, the file of the firmware of the new version) recorded in the directory. Thus, for example, in the CE device 31, the firmware is automatically updated to a new version.

In the above-described processing, the CE device 31 executes the processing by executing software such as a program using the CPU 131 in the CE device 31. Similarly, in the above-described processing, the network connection device 33 or the distribution server 34 executes the processing by executing software such as a program using the network connection device 33 or the CPU 101 in the distribution server.

As described above, the CE device 31, which is not provided with a network connection interface, is notified of or provided with the new information on the Internet 20.

The series of the processing steps described in the description may be time-sequentially executed in the described order. The processing steps may not be time-sequentially executed, but may be executed in parallel or individually executed.

It should be understood that the present disclosure is not limited to the above-described embodiment, and various modifications can be made without departing from the scope of the disclosure.

The present technique may be provided as follows:

(1) An electronic device including:

a drive for attaching a removable storage,

a reader for reading update information acquired from a network through a device having a network connection function when the removable storage is attached to the drive, the information being recorded in a predetermined directory in the removable storage, and

a writer for writing device information necessary for acquiring the update information in a predetermined directory in the removable storage when the removable storage is attached to the drive,

wherein the electronic device is not provided with a function for connecting to the network;

(2) The electronic device described in (1), wherein the device having the network connection function accesses a predetermined server connected to the network, and acquires the update information from the server using the device information stored in the predetermined directory in the removable storage;

(3) The electronic device described in (1) or (2), wherein the device information includes attributes of a predetermined number and attribute values, and

the device having the network connection function specifies the update information to be provided to the electronic device by extracting a predetermined attribute value from the attributes;

(4) The electronic device described in any one of (1) to (3), wherein as the update information, a file of basic software of a new version to be implemented in the electronic device is written;

(5) The electronic device described in any one of (1) to (3), wherein as the update information, contents corresponding a predetermined address on the network are written after being updated;

(6) The electronic device described in any one of (1) to (5), wherein in the device information, a parameter for specifying timing for the device having the network function to access a server connected to the network is described;

(7) The electronic device described in any one of (1) to (8), wherein the device information includes information indicating an operational state of the electronic device, and the device having the network connection function reads the device information recorded in the predetermined directory in the removable storage, accesses a predetermined server connected to the network, and sends the information indicating the operational state of the electronic device to the server;

(8) A method for controlling an electronic device that is not provided with a function of connecting to a network, the method including:

reading update information acquired from the network through a device having a network connection function when a removable storage is attached to a drive for attaching the removable storage, the information being recorded in a predetermined directory in the removable storage, and

writing device information necessary for acquiring the update information in a predetermined directory in the removable storage when the removable storage is attached to the drive;

(9) A program instructing a computer to function as an electronic device that is not provided with a function for connecting to a network, the electronic device including:

a drive for attaching a removable storage,

a reader for reading update information acquired from the network through a device having a network connection function when the removable storage is attached to the drive, the information being recorded in a predetermined directory in the removable storage, and

a writer for writing device information necessary for acquiring the update information in a predetermined directory in the removable storage when the removable storage is attached to the drive; and

(10) A computer-readable storage medium storing the program described in (9).

The present disclosure contains subject matter related to that disclosed in Japanese Priority Patent Application JP 2011-053843 filed in the Japan Patent Office on Mar. 11, 2011, the entire contents of which are hereby incorporated by reference.

What is claimed is:

1. An electronic device comprising:
a drive for attaching a removable storage;
a reader for reading update information acquired from a network through a device having a network connection function when the removable storage is attached to the drive, the information being recorded in a predetermined directory in the removable storage; and
a writer for writing device information necessary for acquiring the update information in a predetermined directory in the removable storage when the removable storage is attached to the drive,
wherein the electronic device is not provided with a function for connecting to the network.

2. The electronic device according to claim 1, wherein the device having the network connection function accesses a predetermined server connected to the network, and acquires the update information from the server using the device information stored in the predetermined directory in the removable storage.

3. The electronic device according to claim 1, wherein the device information includes attributes of a predetermined number and attribute values, and
the device having the network connection function specifies the update information to be provided to the electronic device by extracting a predetermined attribute value from the attributes.

4. The electronic device according to claim 1, wherein as the update information, a file of basic software of a new version to be implemented in the electronic device is written.

5. The electronic device according to claim 1, wherein as the update information, contents corresponding a predetermined address on the network are written after being updated.

6. The electronic device according to claim 1, wherein in the device information, a parameter for specifying timing for the device having the network function to access a server connected to the network is described.

7. The electronic device according to claim 1, wherein the device information includes information indicating an operational state of the electronic device, and the device having the network connection function reads the device information recorded in the predetermined directory in the removable storage, accesses a predetermined server connected to the network, and sends the information indicating the operational state of the electronic device to the server.

8. A method for controlling an electronic device that is not provided with a function of connecting to a network, the method comprising:
reading update information acquired from the network through a device having a network connection function when a removable storage is attached to a drive for attaching the removable storage, the information being recorded in a predetermined directory in the removable storage; and
writing device information necessary for acquiring the update information in a predetermined directory in the removable storage when the removable storage is attached to the drive.

9. A program instructing a computer to function as an electronic device that is not provided with a function for connecting to a network, the electronic device comprising:
a drive for attaching a removable storage;
a reader for reading update information acquired from the network through a device having a network connection function when the removable storage is attached to the drive, the information being recorded in a predetermined directory in the removable storage; and
a writer for writing device information necessary for acquiring the update information in a predetermined directory in the removable storage when the removable storage is attached to the drive.

10. A computer-readable storage medium storing the program according to claim 9.
